(19) United States
(12) Patent Application Publication
(10) Pub. No.: US 2005/0151867 A1
(43) Pub. Date: Jul. 14, 2005

(54) Solid-state image pickup device with CMOS image sensor having amplified pixel arrangement

(76) Inventors: Hiroshige Goto, Yokohama-shi (JP); Ikuko Inoue, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/012,274

(22) Filed: Dec. 16, 2004

(30) Foreign Application Priority Data
Dec. 19, 2003 (JP) 2003-422550

(51) Int. Cl. H04N 3/14; H04N 5/335

(52) U.S. Cl. 348/302; 348/307; 348/308

(57) ABSTRACT

A solid-state image pickup device includes a photodiode, a floating gate transistor, a control circuit, a switching circuit, a reset circuit, and a potential sensing circuit. The photodiode collects and stores signal charges generated in accordance with an amount of incident light. The floating gate transistor has a gate that is placed into one of a floating state and a connecting state and a channel formed under the gate. The channel stores the signal charges. The control circuit controls a transfer of the signal charges between the photodiode and the floating gate transistor. The switching circuit switches the gate of the floating gate transistor from the connecting state to the floating state with given timing. The reset circuit releases the signal charges from the channel of the floating gate transistor. The potential sensing circuit senses a potential of the gate of the floating gate transistor.

### CROSS-REFERENCE TO RELATED APPLICATIONS

This application is based upon and claims the benefit of priority from prior Japanese Patent Application No. 2003-422550, filed Dec. 19, 2003, the entire contents of which are incorporated herein by reference.

### BACKGROUND OF THE INVENTION

1. Field of the Invention

The present invention relates to a solid-state image pickup device, such as a solid-state image pickup device with a CMOS image sensor having an amplified pixel arrangement.

2. Description of the Related Art

Attention has recently been attracted to CMOS image sensors that are one type of a so-called amplified solid-state image pickup device having an output section for each pixel. Of the CMOS image sensors, a four-transistor CMOS image sensor is widely used in which a charge storage unit (photodiode) and a charge sensing unit are separated and the charge sensing unit is formed of a floating diffusion region (see, for example, Jpn. Pat. Appln. KOKAI Publication No. 2001-111900). The four-transistor CMOS image sensor can perform an electronic shutter operation and has a relatively favorable SN ratio.

The four-transistor CMOS image sensor performs an electronic shutter operation as follows. First, signal charges are transferred from photodiodes to floating diffusion regions simultaneously in all pixels. Then, the signal charges are read in line-sequence from the floating diffusion regions. To read out these signal charges, first, the potential of the floating diffusion regions that store the signal charges is sensed. Then, a reset operation of releasing the signal charges from the floating diffusion regions is performed. After that, the potential of the floating diffusion regions is sensed. A given circuit takes a difference between two potentials and senses it as a signal.

However, the above reset operation performed between two potential sensing operations unavoidably introduces reset noise or kTC noise. It therefore causes a problem that the S/N ratio of the sensed signal is impaired.

A prior art four-transistor CMOS image sensor will be described with reference to the accompanying drawings. FIG. 1 shows a circuit arrangement of the prior art four-transistor CMOS image sensor and FIG. 2 shows its operation timing and output waveforms.

Referring to FIG. 1, an area sensor having four (2×2) pixels (cells) P11, P12, P21 and P22 is formed. Each of the pixels is indicated by a broken line. Of the four pixels, the configuration of the pixel P11 will be discussed here.

The pixel P11 includes a photodiode 101, a transfer gate transistor 102, a reset gate transistor 103, a power supply 104, a driver gate transistor 105 of a source follower, an address gate transistor 106, a floating junction (floating diffusion layer) 107, a vertical signal line 108, a power supply 109 of the source follower, a buffer 110, a scan switch 111, a final-output buffer 112, and a scanning register 113.

The pulses applied to the pixels P11 and P12 are a reset signal RS1, a transfer signal TG1 and an address signal ADD1, while the pulses applied to the pixels P21 and P22 are a reset signal RS2, a transfer signal TG2 and an address signal ADD2. These signals are transmitted through the lines shown in FIG. 1. The signals are supplied to the gates of the transistors to generate signals on the vertical signal line 108 in time series as shown in FIG. 2.

The CMOS image sensor operates in integration mode and read mode. In integration mode, the sensor carries out given time integration in a pixel and then transfers and stores charges. In read mode, the sensor reads the stored charges in sequence in accordance with the operation of the integration mode. Assume that the storage node (corresponding to the floating diffusion layer 107), which stores the charges transferred from the pixel, is shielded from light though not shown in FIG. 1, and does not perform photoelectric conversion.

However, the prior art CMOS image sensor shown in FIG. 1 has the following problem. In order to sense signal charges from the pixel P11, they are read out from the signal line 108 while the address signal ADD1 is set at a high (H) level. The potential of the floating diffusion layer 107 that stores signal charges is sensed (A in FIG. 2). Then, the signal charges are released from the floating diffusion layer 107 while the reset signal RS1 is set at a high (H) level (B in FIG. 2), and the potential of the empty floating diffusion layer 107 is sensed (C in FIG. 2). A difference between potentials A and C is regarded as signal charges. A reset operation intervenes between the two potentials and the floating diffusion layer 107 cannot be depleted completely. Noise such as reset noise and kTC noise is therefore superimposed on the signal charges to degrade the quality of signals.

### BRIEF SUMMARY OF THE INVENTION

A solid-state image pickup device according to a first aspect of the present invention, comprises a photodiode which collects and stores signal charges generated in accordance with an amount of incident light; a floating gate transistor having a gate that is placed into one of a floating state and a connecting state in which the gate is supplied with a signal and a channel formed under the gate, the channel storing the signal charges; a control circuit which controls a transfer of the signal charges between the photodiode and the floating gate transistor; a switching circuit which switches the gate of the floating gate transistor from the connecting state to the floating state with given timing; a reset circuit which releases the signal charges from the channel of the floating gate transistor; and a potential sensing circuit which senses a potential of the gate of the floating gate transistor.

A solid-state image pickup device according to a second aspect of the present invention, comprises a photodiode which collects and stores signal charges generated in accordance with an amount of incident light; a floating gate transistor having a gate that is placed into one of a floating state and a connecting state in which the gate is supplied with a signal and a channel formed under the gate, the channel storing the signal charges; a control circuit which controls a transfer of the signal charges between the photodiode and the floating gate transistor; a switching circuit which switches the gate of the floating gate transistor from the connecting state to the floating state with given timing; a reset circuit which releases the signal charges from the channel of the floating gate transistor; a potential sensing circuit which senses a potential of the gate of the floating gate transistor; and an address circuit which changes a signal voltage sensed by the potential sensing circuit into one of an output state and a non-output state in response to an address signal.

A solid-state image pickup device according to a third aspect of the present invention, comprises a photodiode which collects and stores signal charges generated in accordance with an amount of incident light; a floating gate transistor having a gate that is placed into one of a floating state and a connecting state in which the gate is supplied with a signal and a channel formed under the gate, the channel storing the signal charges; a switching circuit which switches the gate of the floating gate transistor from the connecting state to the floating state with given timing; a reset circuit which releases the signal charges from the channel of the floating gate transistor; and a potential sensing circuit which senses a potential of the gate of the floating gate transistor.

### BRIEF DESCRIPTION OF THE SEVERAL VIEWS OF THE DRAWING

FIG. 1 is a circuit diagram showing a configuration of a prior art CMOS image sensor.

FIG. 2 is a timing chart of operation timing and output waveforms of the prior art CMOS image sensor.

FIG. 3 is a circuit diagram showing a configuration of a CMOS image sensor according to a first embodiment of the present invention.

FIG. 4 is a timing chart of operation timing and output waveforms of the CMOS image sensor according to the first embodiment of the present invention.

FIG. 5 is a plan view of the CMOS image sensor according to the first embodiment of the present invention.

FIG. 6 is a sectional view of the CMOS image sensor according to the first embodiment of the present invention.

FIG. 7 is a circuit diagram showing a configuration of a CMOS image sensor according to a second embodiment of the present invention.

FIG. 8 is a timing chart of operation timing and output waveforms of the CMOS image sensor according to the second embodiment of the present invention.

FIG. 9 is a plan view of the CMOS image sensor according to the second embodiment of the present invention.

FIG. 10 is a circuit diagram showing a configuration of a CMOS image sensor according to a third embodiment of the present invention.

FIG. 11 is a timing chart of operation timing and output waveforms of the CMOS image sensor according to the third embodiment of the present invention.

FIG. 12 is a chart of potentials of the CMOS image sensor according to the third embodiment of the present invention in read mode.

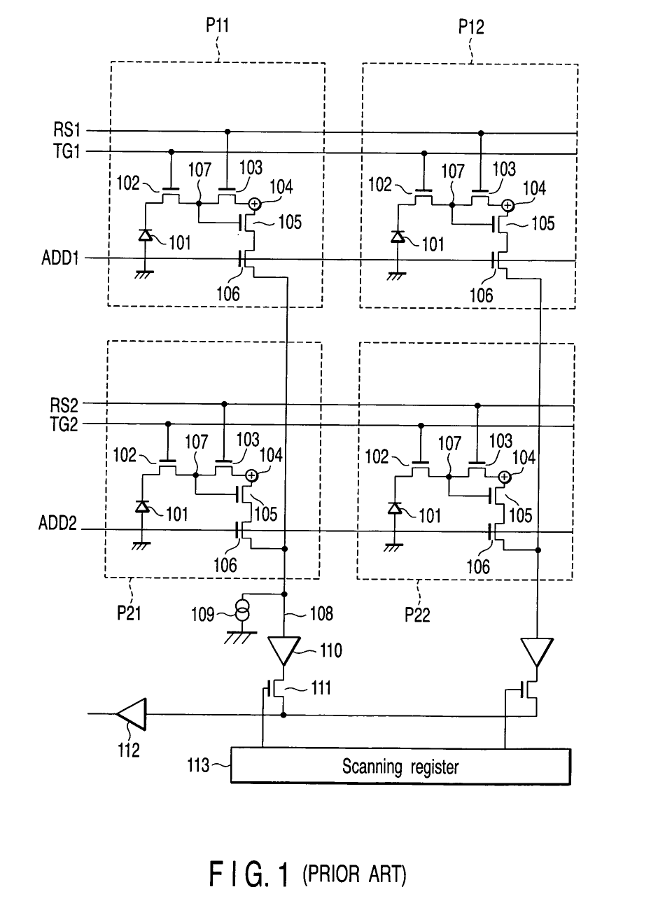

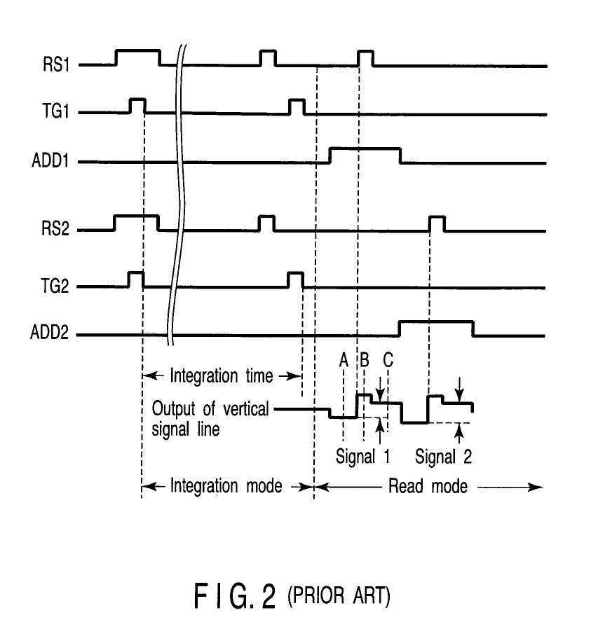

### DETAILED DESCRIPTION OF THE INVENTION

Embodiments of the present invention will be described below with reference to the accompanying drawings. The same components common to all the drawings are indicated by the same reference numerals.

### FIRST EMBODIMENT

A CMOS image sensor will be described as a solid-state image pickup device according to a first embodiment of the present invention.

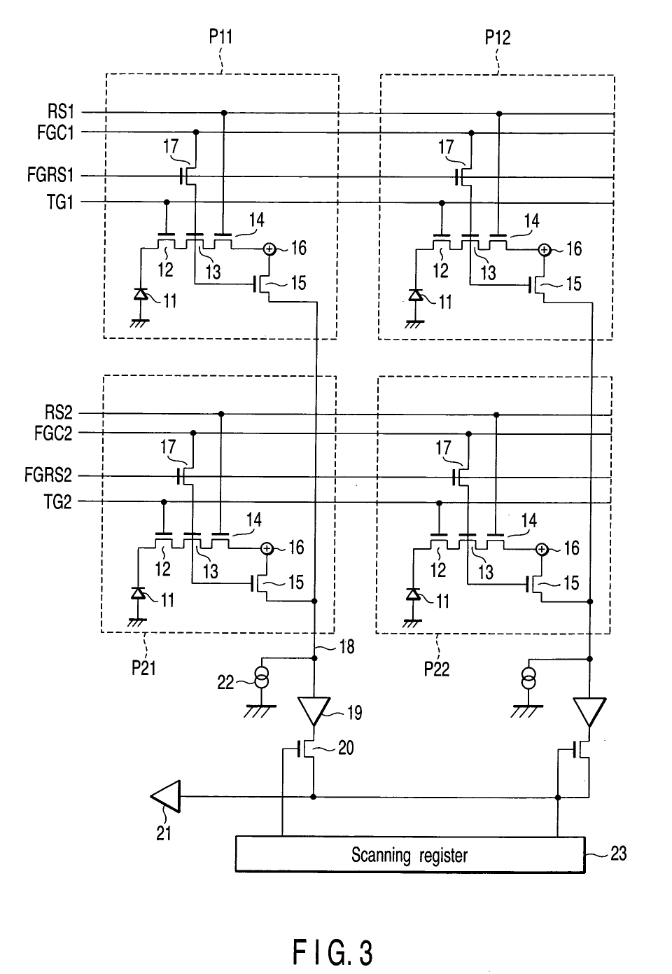

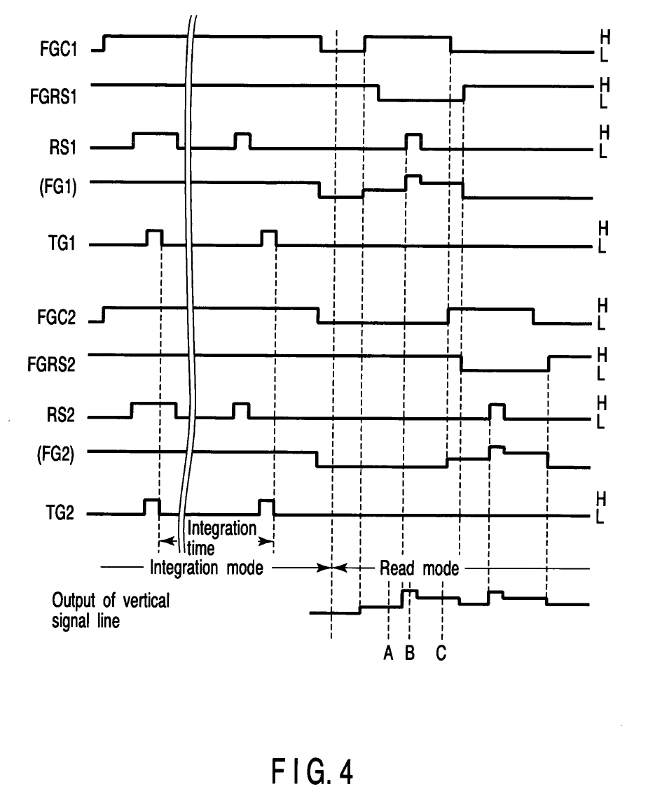

FIG. 3 is a circuit diagram showing a configuration of the CMOS image sensor, and FIG. 4 is a timing chart of operation timing and output waveforms of the CMOS image sensor.

Referring to FIG. 3, an area sensor having four (2×2) pixels (cells) P11, P12, P21 and P22 is formed. Each of the pixels is indicated by a broken line. Of the four pixels, the configuration of the pixel P11 will be discussed here.

The pixel P11 includes a photodiode 11, a transfer gate transistor 12, a floating gate transistor 13, a reset gate transistor 14, a driver gate transistor 15 of a source follower, a power supply 16, and a floating gate potential setting transistor 17. The transistors 12, 13, 14, 15 and 17 are each configured by, e.g., an n-channel MOS transistor.

The photodiode 11 is formed of a pn (or pnp, npn, np) junction and collects and stores signal charges that are generated in accordance with the amount of incident light. The floating gate transistor 13 has a gate that is placed into one of a connecting state in which the gate is supplied with a signal and a floating state and a channel that is formed under the gate. The channel stores signal charges. The transfer gate transistor 12 controls a transfer of signal charges between the photodiode 11 and the floating gate transistor 13. The floating gate potential setting transistor (hereinafter referred to as the potential setting transistor) 17 switches the gate of the transistor 13 from the connecting state to the floating state with given timing. The reset gate transistor 14 serves to release the signal charges from the channel of the transistor 13. The driver gate transistor 15 senses the potential of the gate of the transistor 13.

The cathode of the photodiode 11 is connected to the source of the transfer gate transistor 12, and the drain of the transistor 12 is connected to the source of the floating gate transistor 13. The drain of the transistor 13 is connected to the source of the reset gate transistor 14, and the drain of the transistor 14 is connected to the power supply 16. The gate of the floating gate transistor 13 is connected to the source of the potential setting transistor 17 and the gate of the driver gate transistor 15. The drain of the driver gate transistor 15 is connected to the power supply 16, and the source of the transistor 15 is connected to the input terminal of a buffer 19 through a vertical signal line 18. The output terminal of the buffer 19 is connected to a final-output buffer 21 through a scanning switch transistor 20. The source of the transistor 15 is also connected to a current source 22. The gate of the scanning switch transistor 20 is connected to a scanning register 23.

The pulses applied to the pixels P11 and P12 are a reset signal RS1, a control signal FGC1, a reset signal FGRS1 and a transfer signal TG1. The pulses applied to the pixels P21 and P22 are a reset signal RS2, a control signal FGC2, a reset signal FGRS2 and a transfer signal TG2.

In the pixel P11, the reset signal RS1 is supplied to the gate of the reset gate transistor 14, and the control signal FGC1 is supplied to the gate of the floating gate transistor 13 through the potential setting transistor 17. The reset signal FGRS1 is supplied to the gate of the potential setting transistor 17, and the transfer signal TG1 is supplied to the gate of the transfer gate transistor 12. In the pixel P12, too, the above signals RS1, FGC1, FGRS1 and TG1 are supplied in the same manner as described above. In the pixels P21 and P22, the signals RS2, FGC2, FGRS2 and TG2 are supplied in the same manner as in the pixels P11 and P12.

The CMOS image sensor operates in integration mode and read mode. The integration mode is provided to carry out given time integration in a pixel and then transfer and store signal charges. The read mode is provided to read out the stored signal charges in sequence.

The operation timing of the CMOS image sensor is shown in FIG. 4. The respective signals of the CMOS image sensor are supplied to the gates of the transistors shown in FIG. 3, and the vertical signal line 18 generates signals in time series as shown in FIG. 4.

A reading operation of sensing signal charges from the pixel 11 is as follows. Assume that the signal charges stored in the photodiode 11 are transferred to a channel formed under the gate of the floating gate transistor 13 in integration mode.

First, the control signal FGC1 is set at a low (L) level, the reset signal FGRS1 is set at a high (H) level, the reset signal RS1 is set at a low (L) level, and the transfer signal is set at a low (L) level. Then, the control signal FGC1 is set at a high (H) level to turn on the floating gate transistor 13 and the driver gate transistor 15. Thus, current (electron current) supplied from the current source 22 selectively flows only through a channel formed under the gate of the driver gate transistor 15. The potential generated on the vertical signal line 18 reflects the potential of the channel formed under the gate of the transistor 15.

While the reset signal FGRS1 is set at a low (L) level, the potential setting transistor 17 turns off to place the gate of the floating gate transistor 13 into a floating state. The vertical signal line 18 generates the potential indicated by A in FIG. 4. This potential corresponds to the signal charges stored in the channel under the gate of the transistor 13.

While the reset signal RS1 is set at a high (H) level with the timing shown in FIG. 4, the reset gate transistor 14 turns on. The signal charges are released from the channel under the gate of the transistor 13 (B in FIG. 4). After that, the vertical signal line 18 is set at the potential indicated by C in FIG. 4. This potential represents that no signal charges are stored in the channel under the gate of the transistor 13. The signal sensed from the pixel P11 corresponds to a difference in potential (A-C).

The above reading operation causes neither reset noise nor kTC noise which was a problem of the prior art CMOS image sensor. The reason is as follows. When the signal charges stored in the channel under the gate of the transistor 13 are reset, they are completely released. A signal sensed from a pixel by an electronic shutter operation is a good-quality one on which neither reset noise nor kTC noise is superimposed.

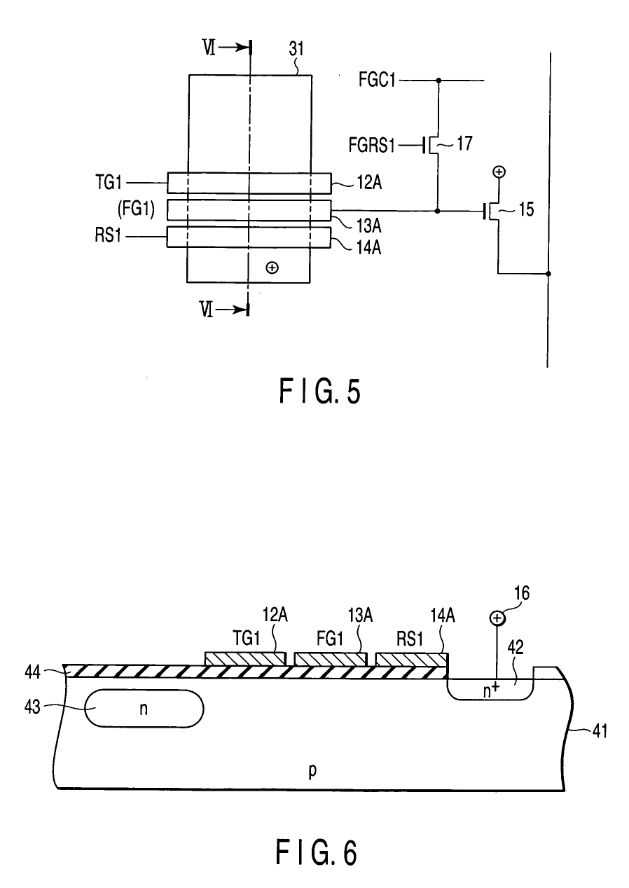

FIG. 5 is a plan view of the CMOS image sensor according to the first embodiment. FIG. 6 is a sectional view of the CMOS image sensor.

Referring to FIG. 5, the gate electrode 12A of the transfer gate transistor 12, the gate electrode 13A of the floating gate transistor 13, and the gate electrode 14A of the reset transistor 14 are arranged on an active region (semiconductor region) 31. The source of the potential setting transistor 17 is connected to the gate electrode 13 of the transistor 13. The drain of the transistor 17 is supplied with a control signal FGC1. The gate electrode 13A of the transistor 13 is connected to the gate of the driver gate transistor 15.

FIG. 6 is a sectional view taken along line VI-VI of FIG. 5. An n⁺-type region 42 is formed in a surface area of a p-type semiconductor substrate 41. An n-type region 43 of the photodiode 11 is buried in the p-type semiconductor substrate 41. A gate oxide film 44 is formed on the substrate 41 and between the regions 42 and 43. The gate electrodes 12A, 13A and 14A are formed on the gate oxide film 44. A semiconductor region for adjusting a threshold value is provided in the substrate 41 and under the gate electrodes 12A, 13A and 14A when the need arises. An overflow drain (not shown) can be provided to release overcharges from the photodiode 11.

According to the first embodiment, a sensing node for sensing signal charges is formed as not a floating diffusion layer but a floating gate, or the sensing node is formed by a channel of a transistor having a gate that is placed into a floating state. When the sensing node is supplied with no signals, a semiconductor region under the floating gate can completely be depleted to prevent reset noise or kTC noise from being generated. A good-quality signal on which neither reset noise nor kTC noise is superimposed can thus be sensed from a pixel.

### SECOND EMBODIMENT

A CMOS image sensor will be described as a solid-state image pickup device according to a second embodiment of the present invention. The same components as those of the first embodiment are denoted by the same reference numerals.

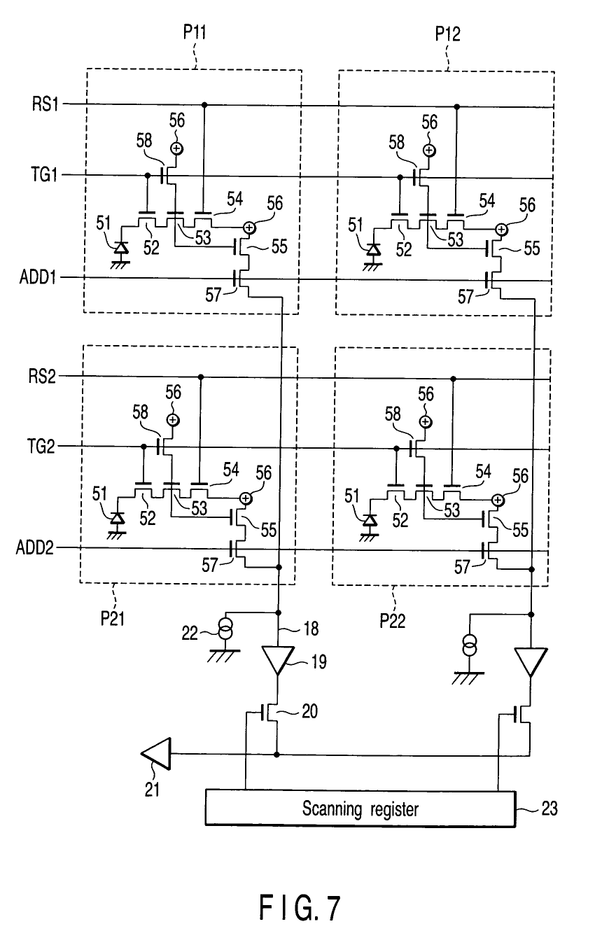

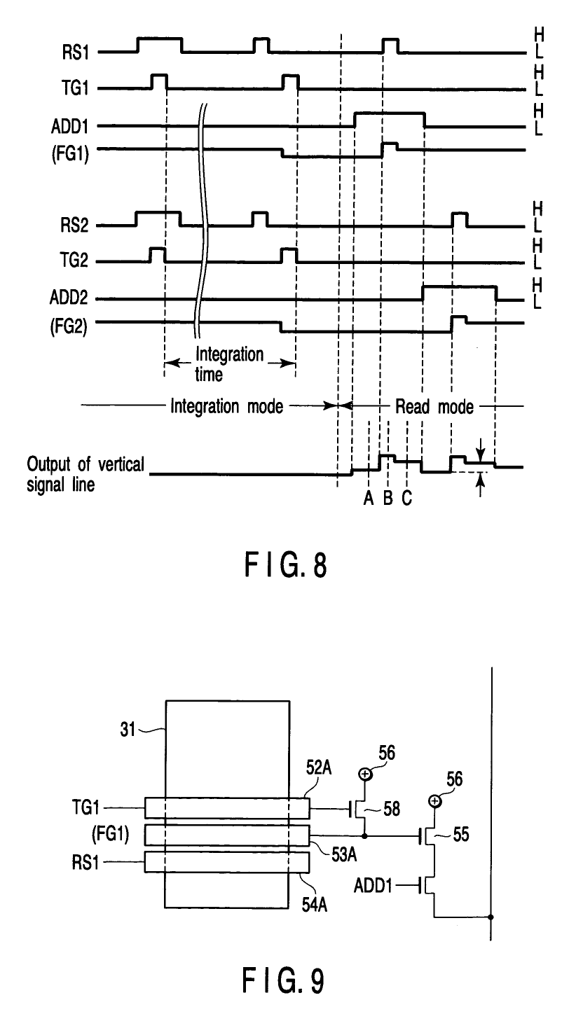

FIG. 7 is a circuit diagram showing a configuration of the CMOS image sensor, and FIG. 8 is a timing chart of operation timing and output waveforms of the CMOS image sensor.

Referring to FIG. 7, a pixel P11 includes a photodiode 51, a transfer gate transistor 52, a floating gate transistor 53, a reset gate transistor 54, a driver gate transistor 55 of a source follower, a power supply 56, an address gate transistor 57, and a floating gate potential setting transistor (referred to as a potential setting transistor) 58. The transistors 52, 53, 54, 55, 57 and 58 are each configured by, e.g., an n-channel MOS transistor.

The cathode of the photodiode 51 is connected to the source of the transfer gate transistor 52, and the drain of the transistor 52 is connected to the source of the floating gate transistor 53. The drain of the transistor 53 is connected to the source of the reset gate transistor 54, and the drain of the transistor 54 is connected to the power supply 56. The gate of the floating gate transistor 53 is connected to the source of the potential setting transistor 58, and the drain of the transistor 58 is connected to the power supply 56. The gate of the floating gate transistor 53 is also connected to that of the driver gate transistor 55. The drain of the transistor 55 is connected to the power supply 16, and the source of the transistor 55 is connected to the drain of the address gate transistor 57. The source of the transistor 57 is connected to the input terminal of a buffer 19 through a vertical signal line 18. The output terminal of the buffer 19 is connected to a final-output buffer 21 through a scanning switch transistor 20. The source of the transistor 57 is also connected to a current source 22. The gate of the scanning switch transistor 20 is connected to a scanning register 23.

In the pixel P11, a reset signal RS1 is supplied to the gate of the reset gate transistor 54. A transfer signal TG1 is supplied to the gates of the transfer gate transistor 52 and potential setting transistor 58. An address signal ADD1 is supplied to the gate of the address gate transistor 57. In the pixel P12, too, the above signals RS1, TG1 and ADD1 are supplied in the same manner as described above. In the pixels P21 and P22, a reset signal RS2, a transfer signal TG1 and an address signal ADD1 are supplied in the same manner as in the pixels P11 and P12.

A reading operation of sensing signal charges from the pixel 11 is as follows. Assume that the signal charges stored in the photodiode 51 are transferred to a channel formed under the gate of the floating gate transistor 53 in integration mode.

First, the gate of the floating gate transistor 53 is placed into a floating state while the reset signal RS1 is set at a low (L) level, the transfer signal TG1 is set at a low (L) level, and the address signal ADD1 is set at a low (L) level. Then, the address signal ADD1 is set at a high (H) level to turn on the address gate transistor 57. Thus, current (electron current) supplied from the current source 22 selectively flows only through a channel formed under the gate of the driver gate transistor 55. The potential generated on the vertical signal line 18 reflects the potential of the channel formed under the gate of the transistor 55. Thus, the vertical signal line 18 generates the potential indicated by A in FIG. 8. This potential corresponds to the signal charges stored in the channel under the gate of the transistor 53.

While the reset signal RS1 is set at a high (H) level with the timing shown in FIG. 8, the signal charges are released from the channel under the gate of the floating gate transistor 53 (B in FIG. 8). After that, the vertical signal line 18 is set at the potential indicated by C in FIG. 8. This potential represents that no signal charges are stored in the channel under the gate of the transistor 53. The signal sensed from the pixel P11 corresponds to a difference in potential (A-C).

The above reading operation causes neither reset noise nor kTC noise which was a problem of the prior art CMOS image sensor. The reason is as follows. When the signal charges stored in the channel under the gate of the transistor 53 are reset, they are completely released. A signal sensed from a pixel by an electronic shutter operation is a good-quality one on which neither reset noise nor kTC noise is superimposed.

FIG. 9 is a plan view of the CMOS image sensor according to the second embodiment.

Referring to FIG. 9, the gate electrode 52A of the transfer gate transistor 52, the gate electrode 53A of the floating gate transistor 53, and the gate electrode 54A of the reset transistor 54 are arranged on an active region (semiconductor region) 31. The source of the potential setting transistor 58 is connected to the gate electrode 53A of the transistor 53. The power supply 56 is connected to the drain of the transistor 58. The gate electrode 53A of the transistor 53 is connected to the gate of the driver gate transistor 55.

According to the second embodiment, a sensing node for sensing signal charges is formed as not a floating diffusion layer but a floating gate, or the sensing node is formed by a channel of a transistor having a gate that is placed into a floating state. When the sensing node is supplied with no-signals, a semiconductor region under the floating gate can completely be depleted to prevent reset noise or kTC noise from being generated. A good-quality signal on which neither reset noise nor kTC noise is superimposed can thus be sensed from a pixel. Furthermore, the second embodiment has the advantage that the number of operation control signals can be reduced more than that in the first embodiment.

### THIRD EMBODIMENT

A CMOS image sensor will be described as a solid-state image pickup device according to a third embodiment of the present invention. The same components as those of the first embodiment are denoted by the same reference numerals.

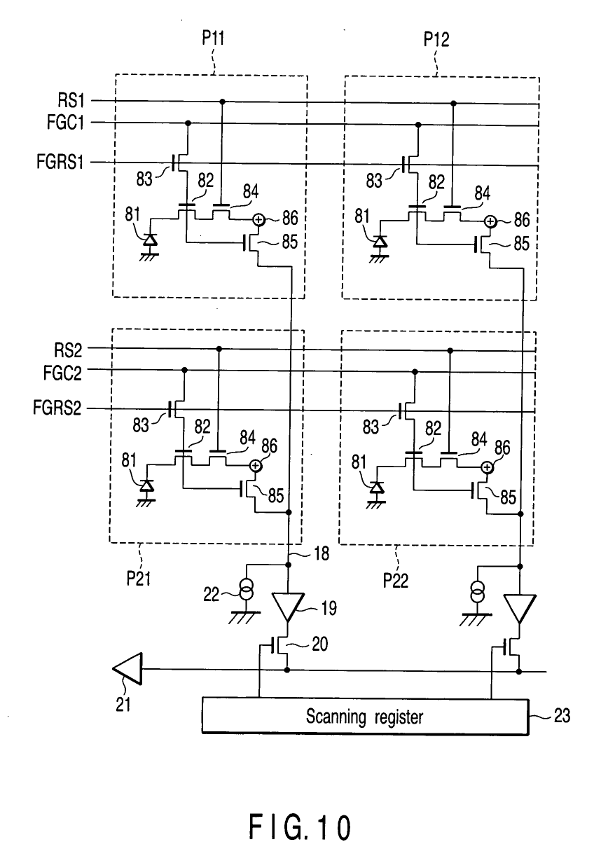

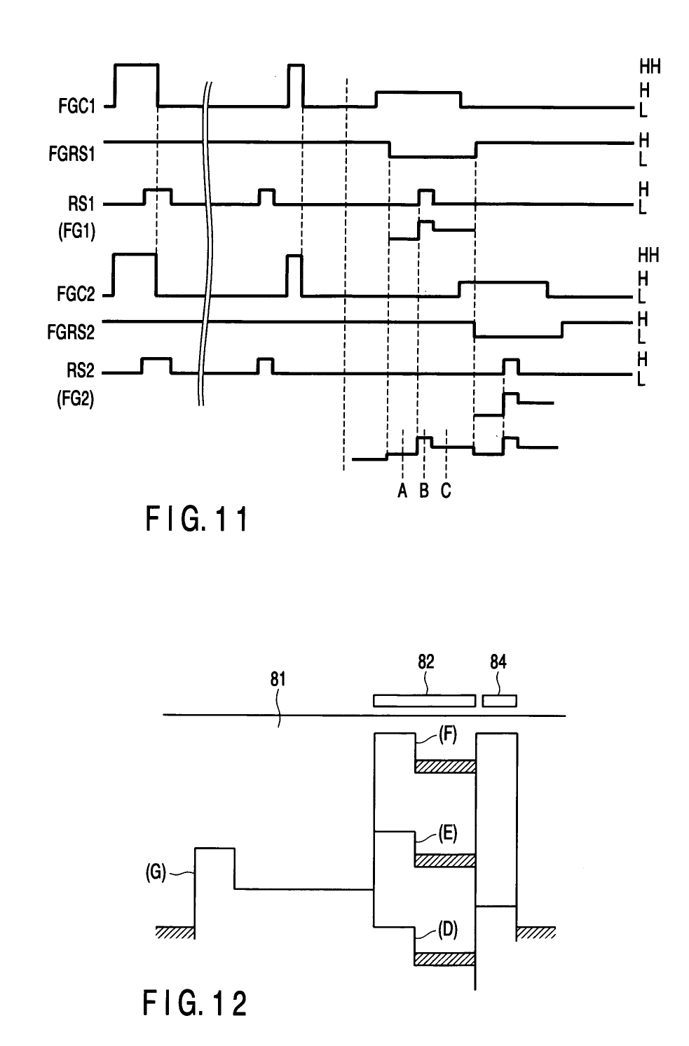

FIG. 10 is a circuit diagram showing a configuration of the CMOS image sensor, and FIG. 11 is a timing chart of operation timing and output waveforms of the CMOS image sensor.

Referring to FIG. 10, a pixel P11 includes a photodiode 81, a shared transistor 82 for a transfer gate transistor and a floating gate transistor, a potential setting transistor 83, a reset gate transistor 84, a driver gate transistor 85 of a source follower, and a power supply 56. The transistors 82, 83, 84 and 85 are each configured by, e.g., an n-channel MOS transistor.

The cathode of the photodiode 81 is connected to the source of the shared transistor 82, and the drain of the transistor 82 is connected to the source of the reset gate transistor 84. The drain of the transistor 84 is connected to the power supply 86. The gate of the transistor 82 is connected to the source of the potential setting transistor 83, and the drain of the transistor 83 is supplied with a control signal FGC1. The gate of the transistor 82 is also connected to that of the driver gate transistor 85. The drain of the transistor 85 is connected to the power supply 86, and the source of the transistor 85 is connected to the input terminal of a buffer 19 through a vertical signal line 18. The output terminal of the buffer 19 is connected to a final-output buffer 21 through a scanning switch transistor 20. The source of the transistor 85 is also connected to a current source 22. The gate of the transistor 20 is connected to a scanning register 23.

In the pixel P11, a reset signal RS1 is supplied to the gate of the reset gate transistor 84. A control signal FGC1 is supplied to the gates of the shared transistor 82 and driver gate transistor 85. A reset signal FGRS1 is supplied to the gate of the potential setting transistor 83. In the pixel P12, too, the above signals RS1, FGC1 and FGRS1 are supplied in the same manner as described above. In the pixels P21 and P22, a reset signal RS2, a control signal FGC2 and a reset signal FGRS2 are supplied in the same manner as in the pixels P11 and P12.

A reading operation of sensing signal charges from the pixel 11 is as follows. Assume that the signal charges stored in the photodiode 81 are transferred to a channel under the gate of the shared transistor 82 including a floating gate transistor in integration mode.

First, the control signal FGC1 is set at a low (L) level, the reset signal FGRS1 is set at a high (H) level, and the reset signal RS1 is set at a low (L) level. Then, the control signal FGC1 is set at a high (H) level to turn on the shared transistor 82 and driver gate transistor 85. The reset signal FGRS1 is set at a low (L) level to turn off the potential setting transistor 83 and place the gate of the transistor 82 into a floating state. Thus, current (electron current) supplied from the current source 22 selectively flows only through a channel formed under the gate of the driver gate transistor 85. The potential generated on the vertical signal line 18 reflects the potential of the channel formed under the gate of the transistor 85. Thus, the vertical signal line 18 generates the potential indicated by A in FIG. 11. This potential corresponds to the signal charges stored in the channel under the gate of the transistor 82.

While the reset signal RS1 is set at a high (H) level with the timing shown in FIG. 11, the signal charges are released from the channel under the gate of the transistor 82 (B in FIG. 11). After that, the vertical signal line 18 is set at the potential indicated by C in FIG. 11. This potential represents that no signal charges are stored in the channel under the gate of the transistor 82 including a floating gate transistor. The signal sensed from the pixel P11 corresponds to a difference in potential (A-C).

The above reading operation causes neither reset noise nor kTC noise which was a problem of the prior art CMOS image sensor. The reason is as follows. When the signal charges stored in the channel under the gate of the shared transistor 82 are reset, they are completely released. A signal sensed from a pixel by an electronic shutter operation is a good-quality one on which neither reset noise nor kTC noise is superimposed.

FIG. 12 shows potentials of the CMOS image sensor according to the third embodiment in the reading operation described above.

The control signal FGC1 applied to the shared transistor 82 has three voltage levels of HH (highest), H (high) and L (low) (HH>H>L), and their corresponding potentials D, E and F are induced as shown in FIG. 12. When the control signal FGC1 is set at the highest (HH) level, signal charges can be transferred from the photodiode 81 to the channel of the shared transistor 82. When the control signal FGC1 is set at a high (H) level and a low (L) level, signal charges can be held in the shared transistor 82. The control signal FGC1 is set at a high (H) level in a pixel from which a signal is sensed, and it is set at a low (L) level in a pixel from which no signal is sensed. The shared transistor 82 can thus be used as an address gate transistor and accordingly the address gate transistor for selecting a pixel can be removed. In FIG. 12, G indicates the potential of the overflow drain described above. The overcharges stored in the photodiode 91 are supplied to the overflow drain.

According to the first embodiment, a sensing node for sensing signal charges is formed as not a floating diffusion layer but a floating gate, or the sensing node is formed by a channel of a transistor having a gate that is placed into a floating state. When the sensing node is supplied with no signals, a semiconductor region under the floating gate can completely be depleted to prevent reset noise or kTC noise from being generated. A good-quality signal on which neither reset noise nor kTC noise is superimposed can thus be sensed from a pixel. Since, moreover, the shared transistor 82 serves as the transfer gate transistor 12 and floating gate transistor 13 of the first embodiment, the transfer signal TG for controlling the operation of the transfer gate transistor 12 can be removed, thereby obtaining the advantage that the cell structure can be simplified.

According to the embodiments of the present invention, there can be provided a solid-state image pickup device that can generate good-quality signal charges on which neither reset noise nor kTC noise is superimposed when an electronic shutter operation is performed.

The foregoing embodiments can be executed not only alone but also in appropriate combination. Each of the embodiments contains inventions in various stages, and these inventions can be extracted from appropriate combinations of a plurality of components disclosed in the embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A solid-state image pickup device comprising:
a photodiode which collects and stores signal charges generated in accordance with an amount of incident light;
a floating gate transistor having a gate that is placed into one of a floating state and a connecting state in which the gate is supplied with a signal and a channel formed under the gate, the channel storing the signal charges;
a control circuit which controls a transfer of the signal charges between the photodiode and the floating gate transistor;
a switching circuit which switches the gate of the floating gate transistor from the connecting state to the floating state with given timing;
a reset circuit which releases the signal charges from the channel of the floating gate transistor; and
a potential sensing circuit which senses a potential of the gate of the floating gate transistor.

2. The solid-state image pickup device according to claim 1, wherein the potential sensing circuit includes a driver transistor having wiring as a gate, the wiring being connected to the gate of the floating gate transistor.

3. The solid-state image pickup device according to claim 1, wherein the floating gate transistor, the control circuit, the switching circuit, the reset circuit, and the potential sensing circuit are each configured by a MOS field effect transistor.

4. The solid-state image pickup device according to claim 3, wherein the MOS field effect transistor of the switching circuit has a current path one end of which is connected to the gate of the floating gate transistor and a gate of the MOS field effect transistor of the potential sensing circuit and other end of which is supplied with a first signal.

5. The solid-state image pickup device according to claim 4, wherein the MOS field effect transistor of the control circuit has a gate that is supplied with a second signal, the MOS field effect transistor of the switching circuit has a gate that is supplied with a third signal, and the MOS field effect transistor of the reset circuit has a gate that is supplied with a fourth signal.

6. The solid-state image pickup device according to claim 1, further comprising a scanning circuit which scans signal voltages output from cells with given timing, the cells being made up of the photodiode, the floating gate transistor, the control circuit, the switching circuit, the reset circuit, and the potential sensing circuit and arranged two-dimensionally on a semiconductor substrate.

7. A solid-state image pickup device comprising:
a photodiode which collects and stores signal charges generated in accordance with an amount of incident light;
a floating gate transistor having a gate that is placed into one of a floating state and a connecting state in which the gate is supplied with a signal and a channel formed under the gate, the channel storing the signal charges;
a control circuit which controls a transfer of the signal charges between the photodiode and the floating gate transistor;
a switching circuit which switches the gate of the floating gate transistor from the connecting state to the floating state with given timing;
a reset circuit which releases the signal charges from the channel of the floating gate transistor;
a potential sensing circuit which senses a potential of the gate of the floating gate transistor; and
an address circuit which changes a signal voltage sensed by the potential sensing circuit into one of an output state and a non-output state in response to an address signal.

8. The solid-state image pickup device according to claim 7, wherein the potential sensing circuit includes a driver transistor having wiring as a gate, the wiring being connected to the gate of the floating gate transistor.

9. The solid-state image pickup device according to claim 7, wherein the floating gate transistor, the control circuit, the switching circuit, the reset circuit, the potential sensing circuit, and the address circuit are each configured by a MOS field effect transistor.

10. The solid-state image pickup device according to claim 9, wherein the MOS field effect transistor of the switching circuit has a current path one end of which is connected to the gate of the floating gate transistor and a gate of the MOS field effect transistor of the potential sensing circuit and other end of which is supplied with a power supply voltage.

11. The solid-state image pickup device according to claim 10, wherein the MOS field effect transistor of the control circuit has a gate that is supplied with a first signal, the MOS field effect transistor of the switching circuit has a gate that is supplied with the first signal, and the MOS field effect transistor of the reset circuit has a gate that is supplied with a second signal.

12. The solid-state image pickup device according to claim 7, further comprising a scanning circuit which scans signal voltages output from cells with given timing, the cells being made up of the photodiode, the floating gate transistor, the control circuit, the switching circuit, the reset circuit, the potential sensing circuit, and the address circuit and arranged two-dimensionally on a semiconductor substrate.

13. A solid-state image pickup device comprising:
a photodiode which collects and stores signal charges generated in accordance with an amount of incident light;
a floating gate transistor having a gate that is placed into one of a floating state and a connecting state in which the gate is supplied with a signal and a channel formed under the gate, the channel storing the signal charges;
a switching circuit which switches the gate of the floating gate transistor from the connecting state to the floating state with given timing;
a reset circuit which releases the signal charges from the channel of the floating gate transistor; and
a potential sensing circuit which senses a potential of the gate of the floating gate transistor.

14. The solid-state image pickup device according to claim 13, wherein the potential sensing circuit includes a driver transistor having wiring as a gate, the wiring being connected to the gate of the floating gate transistor.

15. The solid-state image pickup device according to claim 13, wherein the floating gate transistor, the switching circuit, the reset circuit, and the potential sensing circuit are each configured by a MOS field effect transistor.

16. The solid-state image pickup device according to claim 15, wherein the MOS field effect transistor of the switching circuit has a current path one end of which is connected to the gate of the floating gate transistor and a gate of the MOS field effect transistor of the potential sensing circuit and other end of which is supplied with a first signal.

17. The solid-state image pickup device according to claim 16, wherein the first signal supplied to the other end of the current path of the MOS field effect transistor of the switching circuit has three voltage levels.

18. The solid-state image pickup device according to claim 16, wherein the MOS field effect transistor of the switching circuit has a gate that is supplied with a second signal, and the MOS field effect transistor of the reset circuit has a gate that is supplied with a third signal.

19. The solid-state image pickup device according to claim 13, further comprising a scanning circuit which scans signal voltages output from cells with given timing, the cells being made up of the photodiode, the floating gate transistor, the switching circuit, the reset circuit, and the potential sensing circuit and arranged two-dimensionally on a semiconductor substrate.
